(19) United States
(12) Patent Application Publication
(10) Pub. No.: US 2024/0029169 A1
(43) Pub. Date: Jan. 25, 2024

(54) LIFESTYLE HARDSHIP WAIVER PROTECTING DUES AGAINST LIFESTYLE HARDSHIPS

(71) Applicant: Brian Rock, Oldsmar, FL (US)

(72) Inventor: Brian Rock, Oldsmar, FL (US)

(21) Appl. No.: 18/356,819

(22) Filed: Jul. 21, 2023

Related U.S. Application Data
(60) Provisional application No. 63/391,150, filed on Jul. 21, 2022.

(51) Int. Cl. G06Q 40/08

(52) U.S. Cl. CPC G06Q 40/08

(57) ABSTRACT

Systems, methods, and computer program products provide lifestyle hardship waivers. An exemplary method builds and provides an annual and/or multi-year Consumer waiver, which is a non-insurance plan, written specifically to protect against lifestyle hardships that can financially impact the ability to pay a required annual membership or participation fee of Dues so a Consumer can continue to participate, stay, and/or use or access the benefits and services of the Provider, being delivered and serviced on the world wide web as well as manual and electronic systems while incorporating unique distribution modes that includes appointed Provider who can private label or co-label the product for branding awareness, with the software program(s) allowing the invention to be priced in a variable value and/or specific bands protection for Dues value, hardships sought, years of pre-paid protection, and/or some other denominator related to their financial obligation of required Dues payment to Provider.

### PRIORITY CLAIM

This application claims the benefit of U.S. Provisional Application Ser. No. 63/391,150, filed Jul. 21, 2022, which is hereby incorporated by reference.

### BACKGROUND

Any lack of capitalization or bolding does not change the intent or use of these definitions.
1. Dues: AKA Fees. Means a required window and/or process for the payment of dues and/or fees (including rent) a Consumer must pay to obtain, maintain, and/or access their membership, use, benefits, and/or access rights for a service, benefit, membership, and/or event or activity provided by a Provider, which are reflected by a billing statement and/or invoicing process between the parties. If the Consumer does not pay the required Dues, their access to the service, benefit, and/or event or activity, and/or the ability to belong and/or participate in the Provider service(s) is not accepted, allowed, and/or is terminated by the Provider.
2. Provider: AKA Obligor. Means the entity to whom a Consumer owes the Dues. The Obligor is the provider of the service, benefit, membership, and/or event or activity, who is paid the Dues or Fees by a Consumer, so the Provider will extend participation to the Consumer for the providers' service, benefit, membership, and/or event or activity. An embodiment requires there to be an Obligor relationship with a Consumer (the Obligee), meaning there is a required payment and receipt of Dues between the parties (the Obligor/Provider, who receives the Dues, from the Obligee/Consumer, who pays the Dues).
   Examples of Provider(s) who could qualify, while not all encompassing are in: Timeshare/Vacation Ownership, Travel Clubs, RV and/or campground use membership, Buying Club membership, Homeowners Association, tuition for school or learning based services, and a Club and/or Sports related entity with a Dues requirement to belong and/or participate: Eg: Golf Club, Tennis, and Team sports clubs like Soccer, Baseball, Basketball, Hockey, Football, Lacrosse, Cheer, Crew, Volleyball, Wrestling, etc., where a Consumer pays for participation and/or membership.
3. Consumer: AKA Obligee. Means the purchaser, the person(s) or entity who must pay Dues to obtain, maintain, and/or access a service, benefit, membership, and/or event or activity, and thus may be the holder of the Lifestyle Hardship plan. An embodiment requires there to be an Obligee relationship with a Provider of services (the Obligor), meaning there is a required payment and receipt of Dues between the parties. (the Obligor/Provider, who receives Dues, from the Obligee/Consumer, who pays the Dues).
4. Company: Means the entity whom hosts and allows a Consumer to protect simply their Dues to a Provider on a web based system, without the Consumer having to buy an insurance plan, which includes appointment of parties and/or representatives by the Company to support and/or service the Consumer, systems, and/or process in any manner, including processing or viewing of data and/or the process for evaluating, authenticating, and/or processing a Hardship Request.
5. Lifestyle Hardship(s) means an illness, injury, accident, situation, or event, which occurs to a Consumer such that they feel they have or will have trouble paying their Dues, which would impact their ability to obtain, maintain, and/or access a service, membership, benefit, and/or event or activity with their Provider. Lifestyle Hardships can be things like:
   Death of spouse, domestic partner; family member, relative;
   Death of a parent, or parent in care who is living with Consumer full-time;
   Loss of job for employed, and/or if self-employed, seasonal, part-time and/or full time;
   Damage to home, loss of income from natural disaster and/or other defined peril(s);
   Dismemberment;
   Disability;
   Large medical bills;
   Special Assessment;
   Care, injury, and/or illness of children, step-children, while in the home;
   Care, injury, and/or illness of children, step-children, once they have left home;
   Long-term care;
   Alzheimer's, Dementia, or other diseases;
   Cancer, stroke, heart disease, heart attack;
   Divorce and/or legal separation;
   A consumer feels “I don't want it anymore”, and/or
   Any other lifestyle hardship decided that may be of value to offer.
6. Lifestyle Hardship Request. AKA Hardship Request(s). Means the process whereby a Consumer submits information to the Company for the purposes of evaluating if a Lifestyle Hardship is a protected event via the plan for the Consumer in their situation submitted.

An embodiment relates generally to insurance and, more specifically, the ability to buy a waiver, also considered a warranty type plan, which is a non-insurance plan, on the world wide web that allows the Consumer and the Provider to protect Dues against Lifestyle Hardships that may financially impact the ability to pay and/or receive the Dues, so a Consumer can obtain, maintain, or access their membership use, benefits, and/or access rights for a service, benefit, membership, and/or event or activity provided by a Provider. An embodiment could be used for Providers in a variety of fields where there is a Dues requirement by a Consumer. An embodiment could also be adapted to protect a mortgage against various Lifestyle Hardships, but the key embodiment is the ability to protect only ones Dues, which cannot be done today.

There is no way for a Consumer, or a Provider to the Consumer, to protect only a Consumers' Dues exposure without buying an insurance plan today. From a regulatory standpoint, only certain Consumer/Provider relationships can even qualify for a non-insurance process to protect Dues, so today a consumer must do it via travel insurance. However, the option for a Consumer to protect only Dues in a web enrollment process does not exist if they have no element of travel or vacation travel, meaning the Consumer doesn't want to buy travel insurance or some other insurance plan. An embodiment allows the Consumer or their Provider to access a process to protect only the Dues of the Consumer against defined Lifestyle Hardships, which is offered via an on-line process. An embodiment will help protect and maintain their existing Consumer/Provider relationship, and financially protect the Dues requirement between the parties.

An embodiment can help solve the problem when a Consumer incurs a Lifestyle Hardship which creates a financial hardship under which they or a person who is close to them may impact their financial ability to pay Dues to the Provider, yet the Consumer seeks to maintain their membership rights, use, benefits, and/or access rights to the service, benefit, membership, and/or event or activity. They parties need a solution to the financial hardship of the Consumer.

As a general business rule, the Provider cannot provide their services for free if their business model is built on Dues being required to be paid by Consumer for their benefit(s). When a Consumer cannot pay the expected Dues, the Provider must (a) absorb the lack of Dues not being paid within their operational costs, which increases provider expenses (b) design a payment plan to the Consumer, which adds both time and costs, and may not be successful, and/or (c) terminate the Consumer access to their membership, benefits, services, event, or access, impacting the ability to foster goodwill between the parties without financially impacting the Provider.

An embodiment uses certain variables to create on on-line process to protect only Dues, with factors such as a dollar value and/or specific bands protection for Dues value, Lifestyle Hardships to protect against, years of protection sought, and/or some other denominator related to their financial obligation of required Dues payment between the parties to maintain their privileges. While not limited, other variables may be used or omitted as needed, such as age, marital status, residence location, country, number of family members, salary and more.
There is no on-line ability to protect only ones Dues against Lifestyle Hardships in a self-enrollment process today;
There is no on-line ability to protect only ones Dues against Lifestyle Hardships in a self-enrollment process today, without the Consumer being asked age, salary, and/or medical history to qualify for an enrollment;
The Provider owed Dues has no ability to offer their Consumer an ability to protect their Dues against Lifestyle Hardships in an on-line, self-enrollment web-based process, which can provide some financial security for both parties.
The Provider does not have an on-line process they can access to track and/or process, and/or validate for audits, the transfer funds and pay them the required Dues from a Consumer against Lifestyle Hardships.

### SUMMARY

In various embodiments, an apparatus and method system using hardware, software, unique software programming, database, networks, clouds, and objects related to a non-insurance product, to waive Dues obligations of the Consumer, while making their Provider whole, thereby better protecting both parties and their relationship that is reliant on the Consumer Dues being paid.
In one aspect, an apparatus and/or a method allows the Consumer to have their Dues obligation waived, and the Provider to whom they are obligated be reimbursed when a covered Lifestyle Hardship should occur, without the Consumer having to buy an insurance plan;
In another aspect, an apparatus and a method allows the Consumer to avoid buying travel insurance, which if they wish to protect only their Dues, can require they buy more benefits than the Consumer may seek to purchase;
In still another aspect, an apparatus and a method allows the Provider to avoid insurance licensing requirements, as they can extend a non-insurance benefit to their Consumer for a Dues solution for Lifestyle Hardships;
In yet another aspect, an apparatus and a method allows the Consumer to determine “what” dollar value of Dues they wish to protect, as they will have a choice to the Dues value they seek protected, which may be offered as a fixed amount and/or bands of Dues value to protect;
In a further aspect, an apparatus and a method allows the Consumer to determine “which” Lifestyle Hardships they wish to protect their Dues for, based on their preference for price and value;
In one aspect, an apparatus and a method allows the Consumer to determine “how long” they wish to add Lifestyle Hardships and a value of Dues for, based on their preference for price and value;
In another aspect, an apparatus and a method allows the Provider to customize the Lifestyle Hardship benefits and pricing being offered, creating flexibility to help foster long term stability of the Dues obligations between the parties;
In yet another aspect, an apparatus and a method allows the Provider to private label the protection for Lifestyle Hardship(s) offer within their brand(s), reinforcing the Provider is a viable solution for the Consumer during a Lifestyle Hardship;
In still yet another aspect, an apparatus and a method allows the Provider to save time and expense of wondering “why” their Customer has an issue for paying Dues on time, partially, or at all, as Provider will have a new process to pro-actively learn of the financial hardship of their Consumer, instead of spending Provider resources to learn why the Consumer is delinquent on their Dues payment;
In a further aspect, an apparatus and a method allows the Consumer in a covered Lifestyle Hardship to remain active in the relationship with the Provider, so the Consumer is able obtain, maintain, or access their membership use, benefits, and/or access rights for a service, benefit, membership, and/or event or activity provided by a Provider and be a Consumer in good standing;
In a further aspect, an apparatus and a method allows the Provider to gain data on “why” Consumers have Lifestyle Hardships, how often, and which Lifestyle Hardships occur, which is not statistically known or collected in a comprehensive way today, which will allow the Provider to more accurately price to maintain, and/or access their use, benefits, and/or access rights for a service, benefit, membership, and/or event or activity provided via Dues;
In a further aspect, an apparatus and a method allows the Provider to use the loss data from the Lifestyle Hardships to determine Provider wishes to participate in the risk of loss, or model it differently, without need of an insurance license;
In a further aspect, an apparatus and a method allows the Provider to allow Dues protection of a Lifestyle Hardship for the Consumer paying with and/or using a Provider oriented points-based value, instead of just dollars, or a combination of both dollars and points-based value;
In a further aspect, an apparatus and a method allows the Provider to monetize Dues covered by a Lifestyle Hardship request to be credited back to the Consumer in a Provider oriented points-based value, instead of just dollars; or a combination of both dollars and points-based value;
In a further aspect, an apparatus and a method allows the Consumer to protect Dues exposures in a covered Lifestyle Hardship they might incur and/or be invoiced related to a special assessment and/or damage assessment made by the Provider;
In a further aspect, an apparatus and a method allows the Provider to do a blanket enrollment for a select group of their Consumer membership, without being discriminatory or in violation of insurance law, so they can stratify benefits by membership level and/or other data point, to aid Consumer member loyalty and/or increased yield on their Consumer membership;
In a further aspect, an apparatus and a method allows the Provider to offer Dues protection against Lifestyle Hardships on a global Consumer basis as Provider might seek, without insurance licensing, thus creating benefits and services to their Customers with consistency of application, and helping retain and grow Customers;
In a further aspect, an apparatus and a method allows smaller Providers, and their Consumers to access a way to protect Dues against certain Lifestyle Hardships without a large production requirement for enrollments;
In a further aspect, an apparatus and a method allows both parties to avoid deferring a Dues obligation to a future date, but instead, removing and waiving that Dues obligation between them in a covered Lifestyle Hardship;
In a further aspect, an apparatus and a method allows both parties to extend Lifestyle Hardship protection for spouse, domestic partner; family member(s), and/or relative(s) on an automatic, and/or other data variable, for no and/or additional cost basis;
In a further aspect, an apparatus and a method allows for the specific protection of Dues for Timeshare/Vacation Ownership, Travel Clubs, RV and/or campground use membership, Buying Club membership, Homeowners Association, and any Club and or Sports related entity with a Dues fee requirement to belong and/or participate: Eg: Golf Club, Tennis, and Team sports clubs like Soccer, Baseball, Basketball, Hockey, Football, Lacrosse, Cheer, Crew, Volleyball, Wrestling, etc., that a Consumer pays for participation;
In a further aspect, an apparatus and a method allows for prompt plan issuance and a benefit attachment effective date by Consumer and Provider with prompt notification to same electronically or via telecommunications or mail and that plan documentation between parties via evidence of coverage, binder, and/or posting of data within the world wide web on their specific data;
In a further aspect, an apparatus and a method allows real-time viewing and maintenance of the Consumer's plan, information, and service needs on the world wide web, reducing the need to print documents;
In a further aspect, an apparatus and a method allows action boxes to be checked within the process to activate specific service and pricing for the Consumer, thereby saving time and keystrokes and automatically providing instruction to the Company and/or Provider on what benefit and/or pricing and/or service was requested;
In a further aspect, an apparatus and a method allows tracking and pre-filling data, with internal analysis and/or Consumer or public data, for rating, use, personal information, Company information, Provider information, web delivery tracking, sales channel analysis, benefit usage, analysis and stratification, loss payments, Consumer use, regions, zip codes, time, products, demographics, including habit patterns and histories of purchasers, and any other information that this system collects to assist Consumer, Company, Provider, underwriter, actuary, regulators, or others in analysis, calculations, or other functions related to the underwriting, providing, canceling, withholding, servicing, hardship request case servicing, issuance, or other functions related to this system for a non-insurance plan;
In a further aspect, an apparatus and a method allows accelerated entry by Consumers and system users by having short name/data pre-fills for data, which may include drop down fields to expedite data entry for Consumer, and/or searches for Company systems related to the plan and Consumer data;
In a further aspect, an apparatus and a method allows for remote viewing, online servicing, and/or printing of materials that Consumers, Providers, and/or Company might wish or need to service, maintain, or manage this system and product, plan, services, and benefits via CPU, PDA (personal data assistants), networks, clouds, mail, electronics, telecommunications, paper, or virtual paper copy mediums;
In a further aspect, an apparatus and a method allows for electronic signing or action button as an indication of signing for Hardship Requests, and/or inquiries, reporting, releases, statements, and submission of supporting documents via telecommunications and the world wide web, to expedite Lifestyle Hardship Request processing and reduce paper, as well as by mail;
In a further aspect, an apparatus and a method allows purchase(s) by the Consumer for other non-insurance and insurance-based goods, services, product, benefits, and/or plans if so desired to be offered by the Company and/or Provider;
In a further aspect, an apparatus and a method allows automatic enhancement viewing of web programs via one click for Consumers who may have visual challenges and want larger print to view;
In a further aspect, an apparatus and a method allows the product to be offered, presented, and modified via all its mediums to the Consumers, Providers, and Company to reflect different languages besides English so that it can be evaluated, sold, purchased, managed, and serviced world-wide in countries that do not use English as their primary language;
In a further aspect, an apparatus and a method allows additional Dues limits in pre-established pricing for specific Dues value and/or value bands to be purchased by or provided to the Consumer after the initial purchase for a variety of benefits to expedite and streamline rating processes;

As will be readily appreciated from the foregoing summary, this invention provides a comprehensive solution to both Consumer and Provider when the parties seek to protect only the Dues obligation between the parties.

### BRIEF DESCRIPTION OF THE DRAWINGS

Embodiments are described in detail below with reference to the following drawings. Certain steps are optional and/or may be applied where the diagrams are meant to give a conceptual process that can be modified accordingly from technology changes or improvements, as well as process modifications, while staying within the core concept and unique processes. “Consumer” refers to the member or purchased of the object plan and hosts the processes and who has an affinity relationship with the “distributor”. “Company” refers to the hosting broker of the process, and “distributor(s)” refers to qualifying contracted distributor(s)” appointed by Company, who distribute the object plan in a distribution and marketing process that creates awareness, purchasing opportunities, and/or servicing the object plan for their consumer.

FIG. 1 diagrams the electronic process and method for buying the object plan, so the Consumer can access a Company web portal to view, explore, evaluate buy, price, modify variables, cancel, print, get help, and/or buy or renew, or obtain other member services relating to the system of the present invention, while also seeing the object plan is referenced and affiliated with the Provider.

FIG. 2 diagrams the electronic process and method for providing service on the object plan, for how a Consumer can report a claim, check claims data, service or modify their account, get help, and/or obtain other service or benefits that is available to plan holders and Provider(s) of the system according to one embodiment.

FIG. 3 diagrams the electronic process and method for the financial servicing of the object plan between the Company, and the Provider(s), and how they will be able to communicate, transmit, and receive data that will allow them to reconcile accounts, pay, receive monies, track data, manage data, sort data, order materials, issue policies, cancel policies, reconcile and/or download records on line, track payments, amounts, and status between parties, and other services expected within the system according to one embodiment.

FIG. 4 diagrams the electronic process and method for servicing the object plan for Data Gathering and data process flow, showing multiple input from distributor(s), public access via various web domains, and telecommunications and mail systems, including PDA's or other portable electronic products that can communicate electronically, where the data must be gathered and organized in a central CPU, and then a directive is given to that information such that a process can begin which will result in a communication flow back to the distributor(s) (if applicable) and/or the Consumer via multiple channels depending on how the input was facilitated within the system according to one embodiment.

FIG. 5 diagrams the system apparatus used for buying and servicing the object plan and Consumer benefits of the invention from single and multiple users via various telecommunication and electronic methods and how the data is stored, and then processed by the Company to the Consumer and/or user.

### DETAILED DESCRIPTION OF THE PREFERRED EMBODIMENT

While an embodiment has been illustrated and described, as noted above, many changes can be made via revisions, omissions, options, and change in process order without departing from the spirit and scope of the invention.

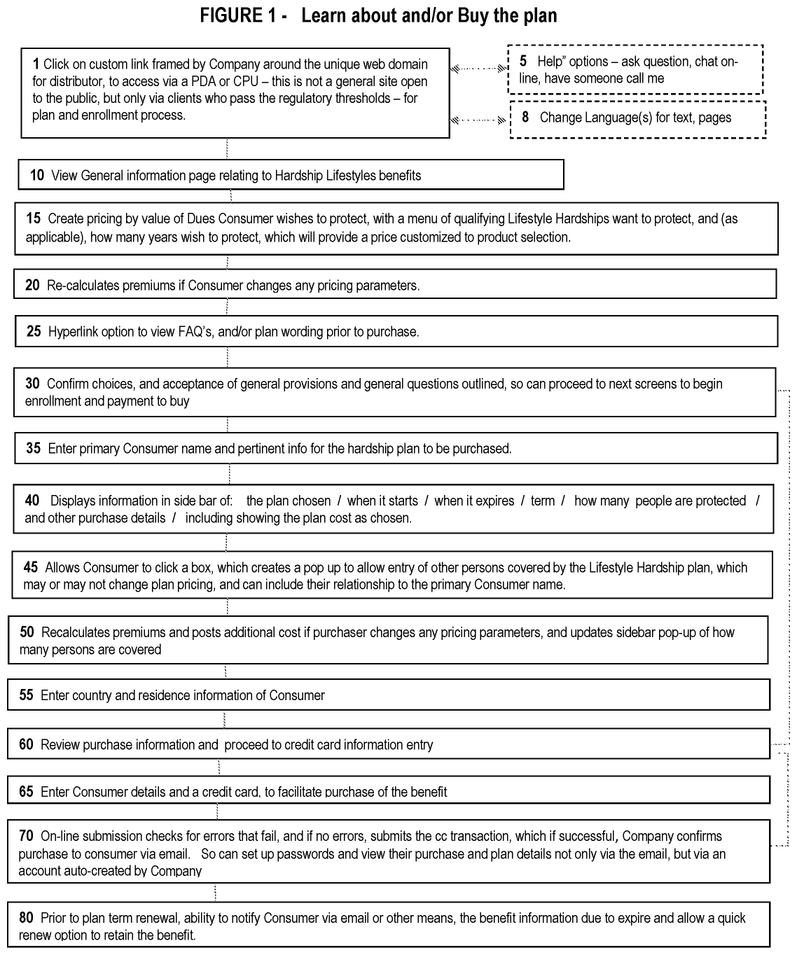

FIG. 1 illustrates a block diagram which is generally noted by reference numerals between 1 and 80 and illustrates a process for buying and servicing the object insurance policy and benefits.

This comprises a process where step 1 is the individual signs on to the web that hosts the object plan and enrollment process, which allows a sidebar “help” feature as per step 5 that allows Consumer to ask a question, get instant messaging on on-line support, and/or request that someone contact them. Step 8 allows the Consumer to click a button to change the language shown on the web pages where it is posted, if seek other than the English language. Step 10 allows them to view a general information page relating to Lifestyle Hardships offered. Consumer can then go to step 15, where they can create a pricing model for the Lifestyle Hardships they wish to protect, against a Dues value they want, and, as applicable other variables like amount of years, etc. Step 20 Recalculates the premium should the consumer change any of the variables used to create the price. Step 25 extends protections to the Consumer via a hyperlink to view Frequently Asked Questions (FAQ's) on the plan, and the actual plan document of benefits, prior to having to actually purchase the plan Step 30 asks the Consumer to affirm by checking a box they agree to the pricing and hardships they chose read and the general provisions and general questions, so they can proceed to next steps which collect their information so can purchase. Step 35 allows them to enter their personal information so we can identify the primary plan holder for the Lifestyle Hardships, including data unique to their identity between them and their Provider. Step 40 auto-populates a sidebar highlight of what they have chosen to purchase, including plan name, benefits, when protection starts, when protection ends, the length of plan term, how many people are protected by the plan and other purchase details including the plan cost. Step 45 allows the purchaser to click “add person” which then populates the fields so the purchaser can then allows them to enter additional person(s) under their plan. Step 50 will highlight any changes in pricing for the additional person(s), which will then update Step 40 for the number of person(s) covered, and well as the plan premium, if applicable. Step 55 asks for the primary purchaser Consumer to enter their information related to country and residence. Step 60 allows the consumer to review their purchase information and if in agreement, proceed to another screen to process their purchase. Step 65 asks the Consumer to enter credit card information and agree to the purchase terms and conditions so Company may process their transaction and issue a plan. Upon a successful credit card transaction, Step 70 is where the system checks for errors or missing data that is required, and if there are any alerts the Consumer to the correction, and if there are not any, submits the provided credit card information of Consumer, which if successful, Company confirms the purchase to the Consumer via email, which allows the Consumer to view purchase and plan details in an email, along with access to a web based environment in an account for the Consumer auto-created by the Company. Step 80 is an optional embodiment whereby there is an ability to notify the Consumer via email or other means that the plan they purchased is due to expire and they can quickly renew protection for their Dues via our process on the world wide web.

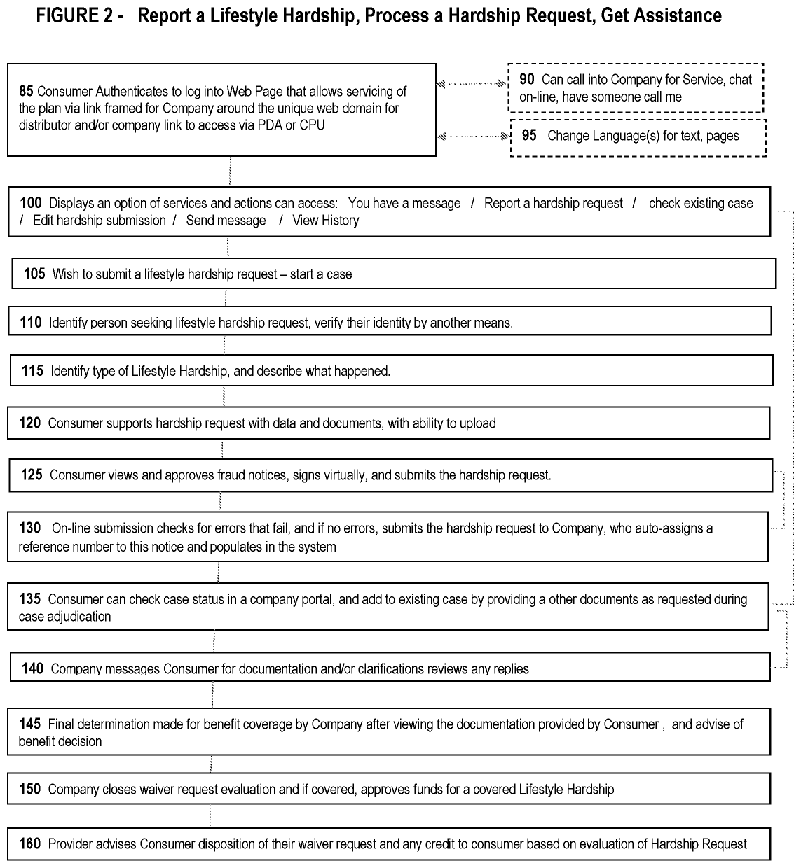

FIG. 2 illustrates a block diagram which is generally noted by reference numerals between 85 and 160 and illustrates a process for requesting a Lifestyle Hardship request, the claims process, and how to get assistance for the object plan.

This comprises identifying different methods of contacting the Company such as step 85, which allows the Consumer who purchased the plan to log into a web page to seek service for reporting a Lifestyle Hardship if a provided benefit for the Consumer after they authenticate access, including step 90, that allows Consumer to and ask a question, get instant messaging on on-line support, and/or request that someone contact them Company for voice support for. Step 95 allows the Consumer to click a button to change the language shown on the web pages where it is posted in if seek other than the English language. Step 100 allows the Consumer to fast access a way to see if the Company has a message for them, Report a Hardship, check the status of an existing request, edit a request already made with additional documentation and/or clarifications or fixes, view history, send a message to Company, or other needs. Step 110 allows the Consumer to start the process to submit a Lifestyle Hardship request, where Step 115 allows the Consumer to identify what type of Lifestyle Hardship they are making a request for, and to free form text in their own words and/or pre-fill what happened. Step 120 prompts the Consumer to attach documentation that relates to their Lifestyle Hardship request so the request can be evaluated by Company or its appointed representative(s). Step 125 prompts the Consumer to review their submission, acknowledge the fraud notice(s), and/or sign the submission virtually, so they can submit their Lifestyle Hardship request. Step 130 is for where the system checks their submission for errors or missing data that is required, and if there are any, alerts the Consumer to the correction, and if there are not any, submits their Lifestyle Hardship request where the system auto-assigns a case number for their hardship request. Step 135 is a process where the Consumer can loop back to step 100 here, as well as if first entering the web portal. Step 140 is a process where the Company messages via the system and/or contacts the Consumer for documentation and/or clarifications on their Hardship Request, so Company can make an informed evaluation if there is a benefit. Once this step is completed, Step 145 occurs which is an evaluation by the Company based on the documentation, or lack of documentation by the Consumer on the Hardship Request, so they can make a benefit decision. Once a decision can be made, step 150 occurs which is when the Company processes their decision and updates the system so Consumer and/or Provider can view the results on the web as applicable, which triggers Company to advise if any waiver is approved for the Lifestyle Hardship request that was submitted. Step 160 is a process whereby the Company and Provider communicate via the system so the Distributor can advise the Consumer on any benefit related to their Hardship Request that was submitted for the non-insurance plan the Consumer had/has.

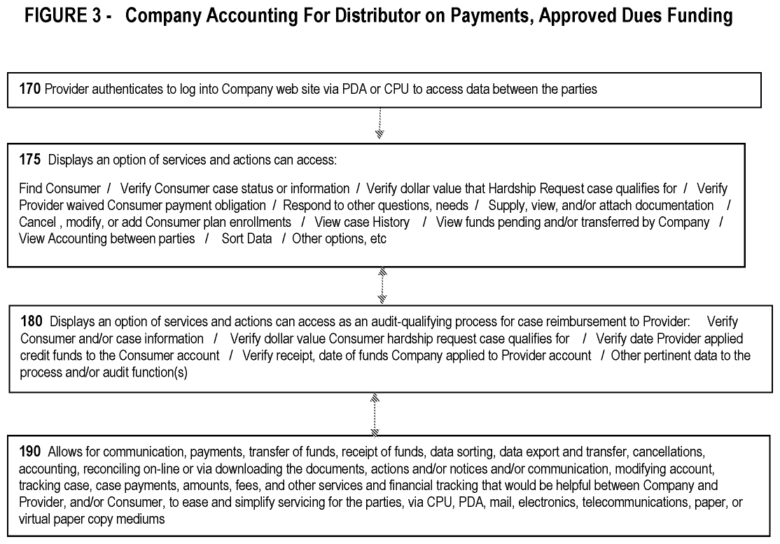

FIG. 3 illustrates a block diagram which is generally noted by reference numerals between 170 and 190 and illustrates a process for how data is viewed, processed, applied, and/or transferred between the Company, the Processor and the Consumer related to servicing hardship requests for the Consumer.

This comprises identifying different methods for the Company to document case status and resolution for a Consumer request and assigned case for a Hardship Request, where step 170 allows the Provider to access a Company web site which hosts pertinent data between the parties once authenticated to access the site. Form there Step 175 allows the Provider to do and/or view a variety of actions including processes such as Find a Consumer; Verify Consumer case status or Information; Verify the dollar value a protected Hardship Request qualified/qualified for; Verify the Provider has waived the Consumer payment obligation to Provider; Respond to other questions or needs; Supply, view, and/or attach documentation; Cancel, Modify, or add plan Consumer enrollments; View case history for Hardship Requests; View Hardship Request case funds pending and/or transferred by Company; View accounting between parties; Sort data; and/or a variety of other processes. Related to this step 180, which creates a refined process so that the transactions for a case and the pending or processing of funds between parties will pass an accounting review or audit and be deemed accurate, such as being able to view Consumer case information; Dollar value Consumer Hardship Request case qualifies/qualified for; Date and/or value of Provider applying the credit of funds to the Consumer account; Date of receipt, and/or value of funds that Company applied/sent to Provider to reflect the approved Hardship Request case that allowed the Provider to waive the Consumer Dues, and any other pertinent data to the process and/or audit functions. Step 190 is the embodiment of all actions and processes that may be encompassed in creating and allowing viewing and/or auditing of this information between the Company and Provider, and/or Consumer.

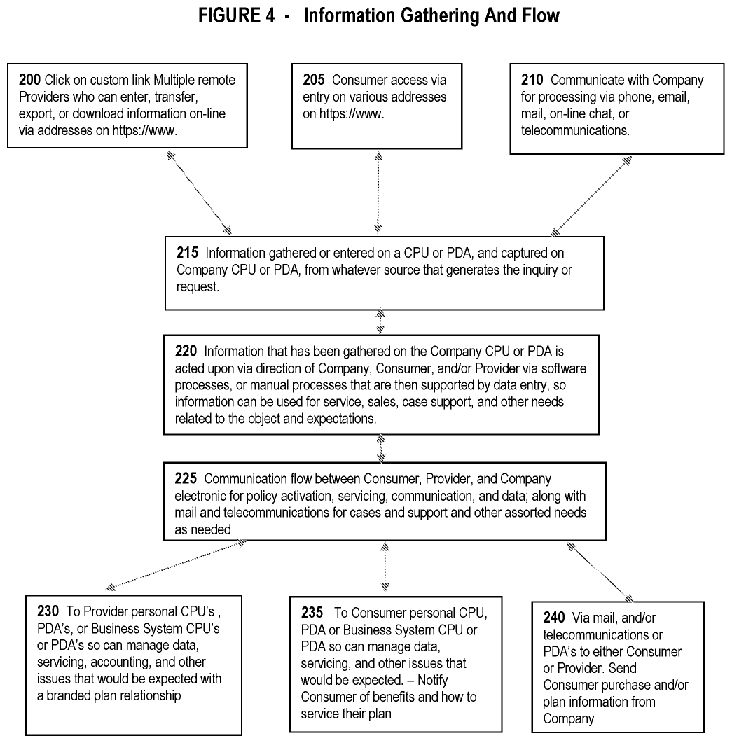

FIG. 4 illustrates a block diagram which is generally noted by reference numerals between 170 and 190 and illustrates a process for how data is gathered and then processed back to the Providers for the object plan and benefits.

This comprises identifying different methods of contacting the Company and gathering and transmitting data, such as data that can originate in step 200 via Providers that can qualify for the required thresholds to offer this plan and processes. Step 205 allows Consumers to access various web sites that may be used to access the plan and/or servicing of the plan they purchased, while step 210 allows the consumer to access the Company via phone, email, regular mail, online chat, or other means of telecommunications. Step 215 reflects the information related to the object plan and process and various parties is captured, gathered, and hosted by Company in a manner that allows for access and use by the respective parties. Step 220 notes that once the information related to the object plan and processes, software will allow the various parties, again Consumer, Company, and/or Provider, to allow for data entry and/or population of data so the information can accessed and/or used for a variety of needs that are related to the object and expectations between parties. Step 225 is a communication flow between the various parties, again Consumer, Company, and/or Provider, via mail and telecommunications for general support including case management for Hardship Requests. Step 230 reflects the software, mail, and/or telecommunications via the Company that is used to support and communicate to the needs for the Provider of the object plan to the Consumer, which can be white labeled under the brand of the Provider. Step 235 reflects the software, mail, and/or telecommunications via the Company that uses to support and communicate to the needs for the Consumer of the object plan. Step 240 reflects the software, mail, and/or telecommunications via the Company that uses to support and communicate to the needs for the Provider and/or Consumer of the object plan.

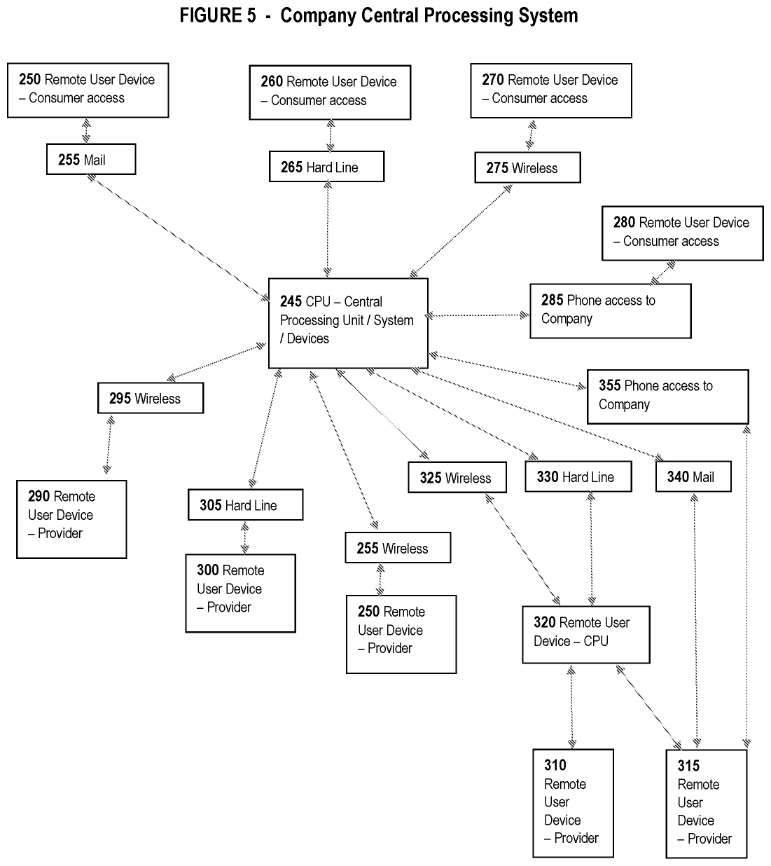

FIG. 5 illustrates a block diagram which is generally noted by reference numerals between 245 and 340 and illustrates the system apparatus for purchasing and servicing the object plan and benefits between various users and mediums.

It operates via the Company Central Processing System, which is the apparatus comprising phone rooms, mail rooms, networks, clouds, service assistants, claims representative, personnel, and electronic hub of the Company where data is processed and acted upon, even those that are redundant or remote, for they must come to a central processing point within the methods and process, comprising hardware, software (i.e., non-transitory computer-readable medium), software programming, database, networks, clouds, and objects related to a custom non-insurance plan to build and provide apparatus that lets data flow and processes be managed and incorporated that allow for efficient processing, communicating, and servicing of the plan. This is depicted by step 245, the company CPU, electronics, and database and apparatus, which collects, organizes, and facilitates action processes on the information and data that has been originated in the Central Processing Systems. Steps 250 to 285 shows the apparatus connections via wireless and wired technologies monitors, internet cloud-based hosting, and phone so the data can be transmitted between Consumer and public into the Company CPU. Steps 290 to 330 shows display apparatus connections via wireless and wired technologies, monitors, internet cloud-based hosting, and phone so the data can be transmitted between Provider into the Company CPU. Steps 335 to 340 shows alternate and/or supplemental connections via wireless and wired technologies, monitors, internet cloud-based hosting, and phone, and mail, so the data can be transmitted between Provider into the Company CPU.

What is claimed is:

1. A method performed by a computer system instructed by non-transitory computer-readable medium, the method comprising:
receiving an applicant selection of dues to protect relative to one or more lifestyle hardship and a number of years to protect value;
creating a plan based on the user selection;
presenting the plan start date, expiration date, term, and plan details;
activating the plan upon receiving a user activation input.

2. The method of claim 1, further comprising:
before creating the plan,
receiving a user selection of others to be covered by the plan and their relationship to the applicant; and
receiving a user selection of country and residence information for the applicant.

3. The method of claim 1, further comprising:
receiving a lifestyle hardship request initiation from a user;
identifying a person making the hardship request initiation;
receiving lifestyle hardship information associated with the hardship request initiation;
generating a decision for the hardship request initiation; and
outputting the decision to the user.

4. The method of claim 3, further comprising:
determining if the lifestyle hardship information is complete; and
requesting missing information if the lifestyle hardship information is not complete.

5. The method of claim 3, further comprising:
approving funds for a lifestyle hardship, if the decision indicates the lifestyle hardship request initiation is covered by the plan.

6. The method of claim 3, further comprising:
recording lifestyle hardship request initiation;
identifying trends based on the recorded lifestyle hardship request initiation; and
using the identified trends when creating future plans.

7. The method of claim 1, wherein dues include dues associated with any of a timeshare/vacation ownership, a travel club, a recreational vehicle or campground use membership, a buying club membership, a homeowner's association, tuition for school or learning based services, a club, or sports related entity, or a team sports club.

8. A computer program product stored on a non-transitory computer-readable medium, when executed by a processor the computer program project causes the processor to:
receive an applicant selection of dues to protect relative to one or more lifestyle hardship and a number of years to protect value;
create a plan based on the user selection;
present the plan start date, expiration date, term, and plan details;
activate the plan upon receiving a user activation input.

9. The computer program product of claim 8, wherein the computer program project further causes the processor to:
receive user selection of others to be covered by the plan and their relationship to the applicant before creating the plan; and
receive a user selection of country and residence information for the applicant before creating the plan.

10. The computer program product of claim 8, wherein the computer program project further causes the processor to:
receive a lifestyle hardship request initiation from a user;
identify a person making the hardship request initiation;
receiving lifestyle hardship information associated with the hardship request initiation;
generate a decision for the hardship request initiation; and
output the decision to the user.

11. The computer program product of claim 10, wherein the computer program project further causes the processor to:
determine if the lifestyle hardship information is complete; and
request missing information if the lifestyle hardship information is not complete.

12. The computer program product of claim 10, wherein the computer program project further causes the processor to:
approve funds for a lifestyle hardship, if the decision indicates the lifestyle hardship request initiation is covered by the plan.

13. The computer program product of claim 10, wherein the computer program project further causes the processor to:
record lifestyle hardship request initiation;
identify trends based on the recorded lifestyle hardship request initiation; and
use the identified trends when creating future plans.

14. The computer program product of claim 8, wherein dues include dues associated with any of a timeshare/vacation ownership, a travel club, a recreational vehicle or campground use membership, a buying club membership, a homeowner's association, tuition for school or learning based services, a club, or sports related entity, or a team sports club.

15. A system comprising:
a processor; and
a computer program product stored on a non-transitory computer-readable medium, when executed by the processor the computer program project causes the processor to:
receive an applicant selection of dues to protect relative to one or more lifestyle hardship and a number of years to protect value;
create a plan based on the user selection;
present the plan start date, expiration date, term, and plan details;
activate the plan upon receiving a user activation input.

16. The system of claim 15, wherein the computer program project further causes the processor to:
receive user selection of others to be covered by the plan and their relationship to the applicant before creating the plan; and
receive a user selection of country and residence information for the applicant before creating the plan.

17. The system of claim 15, wherein the computer program project further causes the processor to:
receive a lifestyle hardship request initiation from a user;
identify a person making the hardship request initiation;
receiving lifestyle hardship information associated with the hardship request initiation;
generate a decision for the hardship request initiation; and
output the decision to the user.

18. The system of claim 17, wherein the computer program project further causes the processor to:
determine if the lifestyle hardship information is complete; and
request missing information if the lifestyle hardship information is not complete.

19. The system of claim 17, wherein the computer program project further causes the processor to:
approve funds for a lifestyle hardship, if the decision indicates the lifestyle hardship request initiation is covered by the plan.
record lifestyle hardship request initiation;
identify trends based on the recorded lifestyle hardship request initiation; and
use the identified trends when creating future plans.

20. The system of claim 15, wherein dues include dues associated with any of a timeshare/vacation ownership, a travel club, a recreational vehicle or campground use membership, a buying club membership, a homeowner's association, tuition for school or learning based services, a club, or sports related entity, or a team sports club.
